(19) United States
(12) Patent Application Publication
(10) Pub. No.: US 2026/0027963 A1
(43) Pub. Date: Jan. 29, 2026

(54) ACCESSORY RAIL SYSTEM

(71) Applicant: Ford Global Technologies, LLC, Dearborn, MI (US)

(72) Inventors: Bradford Zercoe, San Jose, CA (US); Christine Zhou, Diamond Bar, CA (US); Javor Gnjidic, Costa Mesa, CA (US); Eva Ross, Hermosa Beach, CA (US); Stephen Jeffrey Moneypenny, San Diego, CA (US)

(21) Appl. No.: 18/786,500

(22) Filed: Jul. 28, 2024

(51) Int. Cl. B60P 7/08; B60R 9/06

(52) U.S. Cl. CPC B60P 7/0815; B60R 9/06

(57) ABSTRACT

A system includes a first rail extendable along a first side wall defining a cargo area and a second rail extendable along a second side wall defining the cargo area. The first rail and the second rail each include at least one mount interface to attach to a respective one of the first side wall and the second side wall. One or more accessories are selectively mountable to at least one of the first rail and the second rail. At least one protector is associated with the first rail and the second rail, wherein the at least one protector is moveable between an accessible position and a non-accessible position. When in the accessible position, each mount interface is accessible to remove or attach the first rail and the second rail, or each of the first rail and second rail are accessible to remove or attach the one or more accessories. When in the non-accessible position, each mount interface is inaccessible to remove or attach the first rail and the second rail, or each of the first rail and second rail are inaccessible to remove or attach the one or more accessories.

### TECHNICAL FIELD

This disclosure relates generally to an accessory rail system, and relates more specifically to an accessory rail system where the rails can be securely fixed to bed side walls and where the accessory members can be securely locked to the rails.

### BACKGROUND

Vehicles transport various types of cargo. A user can, for example, rely on a vehicle to transport accessories, such as boxes, containers and tools, to and from a jobsite. The accessories that need to be transported can vary based on the tasks the user performs at the jobsite. Providing different support configurations within a cargo area to accommodate the various accessories may be challenging.

### SUMMARY

A system according to an exemplary aspect of the present disclosure includes, among other things: a first rail extendable along a first side wall defining a cargo area; a second rail extendable along a second side wall defining a cargo area, and wherein the first rail and the second rail each include at least one mount interface to attach to a respective one of the first side wall and the second side wall; one or more accessories that are selectively mountable to at least one of the first rail and the second rail; and at least one protector associated with the first rail and the second rail, wherein the at least one protector is moveable between an accessible position and a non-accessible position, and wherein in the accessible position each mount interface is accessible to remove or attach the first rail and the second rail, or each of the first rail and second rail are accessible to remove or attach the one or more accessories, and in the non-accessible position each mount interface is inaccessible to remove or attach the first rail and the second rail, or each of the first rail and second rail are inaccessible to remove or attach the one or more accessories.

In a further non-limiting embodiment of any system, at least one connector is associated with each mount interface, wherein the at least one connector fixes a respective one of the first rail and the second rail to and associated one of the first side wall and the second side wall.

In a further non-limiting embodiment of any system, the at least one protector comprises a bar that is slidably received within a track formed in each of the first rail and the second rail, and wherein each bar includes at least one opening such that when the bar is in the accessible position the at least one opening is aligned with the at least one mount interface, and when the bar is in the non-accessible position the at least one opening is not aligned with the at least one mount interface.

In a further non-limiting embodiment of any system, each mount interface includes a first mounting opening formed in an associated one of the first rail and the second rail, and a second mounting opening formed in an associated one of the first side wall and the second side wall, and wherein the at least one connector is insertable through the first mounting opening and the second mounting opening to fix a respective one of the first rail and the second rail to an associated one of the first side wall and the second side wall.

In a further non-limiting embodiment of any system, when the bar is in the accessible position, the at least one opening is aligned with the first mounting opening and the second mounting opening, and when the bar is in the non-accessible position the at least one opening is not aligned with the first mounting opening and the second mounting opening.

In a further non-limiting embodiment of any system, each of the first rail and the second rail extend to a distal end that faces a tailgate that is moveable between an open position and a closed position, and wherein when the tailgate is in the closed position, the bar is prevented from moving to the accessible position, and when the tailgate is in the open position, the bar is moveable toward the distal end to achieve the accessible position.

In a further non-limiting embodiment of any system, each mount interface comprises a post that offsets the first rail and the second rail from a respective one of the first side wall and the second side wall.

In a further non-limiting embodiment of any system, each mount interface comprises a first mounting opening in the first side wall or second side wall and a second mounting opening in an associated one of the first rail and the second rail that are aligned with each other to allow the first rail and the second rail to be flush mounted to a respective one of the first side wall and the second side wall.

In a further non-limiting embodiment of any system, the at least one protector comprises a tailgate that is moveable between an open position and a closed position, and wherein, when the tailgate is in the closed position, accessories are not removable from the first rail and the second rail, and when in the open position, accessories are removable from the first rail and the second rail.

In a further non-limiting embodiment of any system, each of the first rail and the second rail have a track that extends to a distal end with an open end face, and wherein the one or more accessories are selectively detachable and attachable to the first rail and the second rail by accessing the track via the open end face, and wherein when the tailgate is in the closed position, the open end face is closed off, and when the tailgate is in the open position, the open end face is open.

In a further non-limiting embodiment of any system, the one or more accessories comprise one or more panels that are supported by the first rail and the second rail in one of a plurality of different configurations, and wherein the plurality of different configurations include at least a cargo divider configuration, an acro cover configuration, a security cover configuration, or a tiered cargo configuration.

In a further non-limiting embodiment of any system, the first rail extends substantially along an entirety of the first side wall and wherein the second rail extends substantially along an entirety of the second side wall.

In a further non-limiting embodiment of any system, the at least one protector comprises at least a first protector that is moveable between an accessible position and a non-accessible position relative to the at least one mount interface, and at least a second protector that is moveable between an accessible position to attach or remove the one or more accessories and a non-accessible position where the one or more accessories cannot be removed or attached.

In a further non-limiting embodiment of any system, at least one accessory attachment slider is received in at least one of the first rail and the second rail, wherein the one or more accessories are supported by the at least one accessory attachment slider, and wherein, once installed in the at least one of the first rail and the second rail, the at least one accessory attachment slider is actuatable between an unlocked position where the at least one accessory attachment slider is freely slidable along the first rail and the second rail and a locked position where the at least one accessory attachment slider is held fixed in the at least one of the first rail and the second rail.

A method according to an exemplary aspect of the present disclosure includes, among other things: mounting a first rail along a first side wall defining a cargo area via at least a first mount interface; mounting a second rail along a second side wall defining the cargo area via at least a second mount interface; selectively mounting one or more accessories to at least one of the first rail and the second rail; and associating at least one protector with the first rail and the second rail, wherein the at least one protector is moveable between an accessible position and a non-accessible position, and wherein in the accessible position each mount interface is accessible to remove or attach the first rail and the second rail, or each of the first rail and second rail are accessible to remove or attach the one or more accessories, and in the non-accessible position each mount interface inaccessible to remove or attach the first rail and the second rail, or each of the first rail and second rail are inaccessible to remove or attach the one or more accessories.

In a further non-limiting embodiment of any method, the method includes installing at least one connector the first mount interface to fix the first rail to the first side wall and installing at least one connector the second mount interface to fix the second rail to the second side wall.

In a further non-limiting embodiment of any method, the at least one protector comprises a bar, and the method includes sliding the bar within a track formed in each of the first rail and the second rail, and providing at least one opening in each bar such that when the bar is in the accessible position the at least one opening is aligned a respective one of the first mount interface and the second mount interface, and when the bar is in the non-accessible position the at least one opening is not aligned with the respective one of the first mount interface and the second mount interface.

In a further non-limiting embodiment of any method, each of the first mount interface and the second mount interface includes a first mounting opening formed in an associated one of the first rail and the second rail, and a second mounting opening formed in an associated one of the first side wall and the second side wall, and the method includes inserting the at least one connector through the first mounting opening and the second mounting opening to fix a respective one of the first rail and the second rail to an associated one of the first side wall and the second side wall.

In a further non-limiting embodiment of any method, when the bar is in the accessible position, the at least one opening is aligned with the first mounting opening and the second mounting opening, and when the bar is in the non-accessible position the at least one opening is not aligned with the first mounting opening and the second mounting opening, and wherein each of the first rail and the second rail extend to a distal end that faces a tailgate that is moveable between an open position and a closed position, and the method includes preventing the bar from moving to the accessible position by moving the tailgate to the closed position, and allowing the bar to move to the accessible position by moving the tailgate to the open position.

In a further non-limiting embodiment of any method, the at least one protector comprises a tailgate that is moveable between an open position and a closed position, and the method includes removing accessories from the first rail and the second rail by moving the tailgate to the open position, and preventing accessories from being removed from the first rail and the second rail by moving the tailgate to the closed position, and optionally:
including sliding at least one accessory attachment slider in at least one of the first rail and the second rail, supporting the one or more accessories with the at least one accessory attachment slider, and wherein, once installed in the at least one of the first rail and the second rail, the at least one accessory attachment slider is actuatable between an unlocked position where the at least one accessory attachment slider is freely slidable along the first rail and the second rail and a locked position where the at least one accessory attachment slider is held fixed in the at least one of the first rail and the second rail.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of an accessory rail system in a cargo area of a truck bed with a tailgate in an open position.

FIG. 2A illustrates a perspective view of an accessory rail system with a protector in an accessible position to allow rails to be attached or detached from a side wall of the truck bed.

FIG. 2B is similar to FIG. 2A but shows the protector in a non-accessible position to prevent the rails from being detached from the side wall of the truck bed.

FIG. 3 illustrates a perspective view of another example of an accessory rail system in a cargo area of a truck bed with a tailgate in an open position.

FIG. 4A illustrates a perspective view of one example of an accessory attachment slider that is actuatable between an unlocked position and a locked position.

FIG. 4B is a section view of the accessory attachment slider of FIG. 4B.

FIG. 4C is an end view of the accessory attachment slider of FIG. 4A showing rotation between locked and unlocked positions.

FIG. 5A illustrates a perspective view of one example of an accessory that comprises one or more panels that are supported by the first rail and the second rail in one configuration of a plurality of different configurations.

FIG. 5B illustrates a perspective view of another example configuration for the one or more panels.

FIG. 5C illustrates a perspective view of another example configuration for the one or more panels.

FIG. 5D illustrates a perspective view of another example configuration for the one or more panels.

### DETAILED DESCRIPTION

This disclosure relates generally to an accessory rail system, and relates more specifically to an accessory rail system where the rails can be securely fixed to bed side walls and where the accessory members can be securely locked to the rails. In implementations, an accessory attachment slider, which supports one or more accessories on the rails, is actuatable between locked an unlocked positions. Further, the disclosure provides accessories that comprise one or more panels that can provide for multiple different panel configurations with a cargo area of a truck bed.

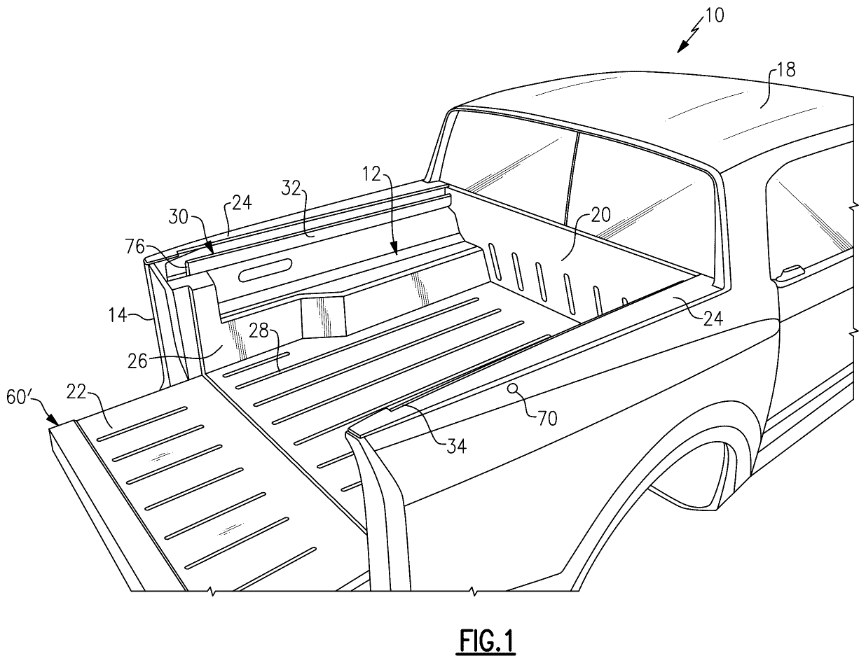

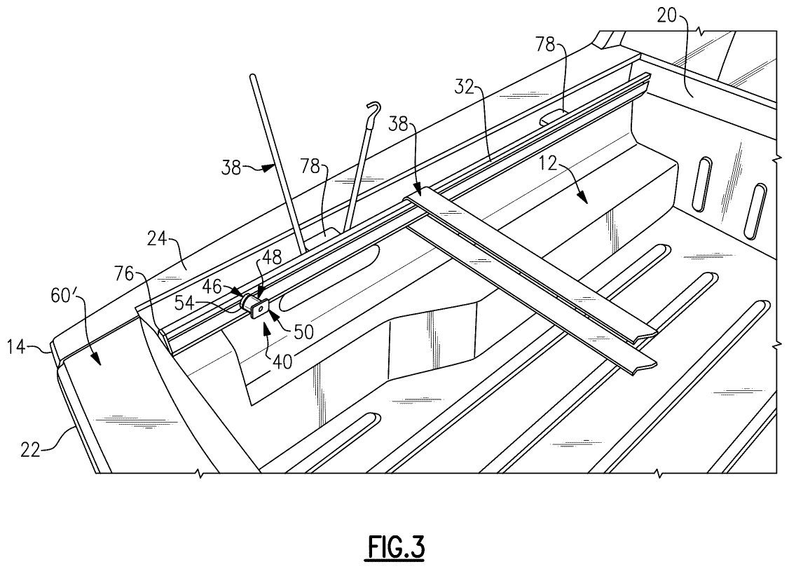

FIG. 1 shows a vehicle 10 with a cargo area 12 defined by a first side wall 14 and a second side wall 16 facing opposite the first side wall 14. A passenger cab 18 is at a front of the vehicle and a front bed wall 20 extends along a back of the passenger cab 18 between the first side wall 14 and the second side wall 16 to enclose a front end of the cargo area 12. A tailgate 22 is positioned at a rear of the vehicle 10 and is moveable between an open position and a closed position. FIG. 1 shows the tailgate 22 in the open position, and when the tailgate 22 is moved to the closed position (FIG. 3) a rear wall of the cargo area 12 is provided.

The first side wall 14 and the second side wall 16 extend along a length of the cargo area 12 in a longitudinal direction, e.g., along a length of the vehicle 10. Each of the first side wall 14 and the second side wall 16 include a top edge or top surface 24 and an inner wall surface 26 that faces the cargo area 12. A bottom bed surface 28 extends in a lateral direction, e.g., across a width of the vehicle 10, between the inner wall surfaces 26 of the first side wall 14 and the second side wall 16. The bottom bed surface 28 also extends in the longitudinal direction from the front bed wall 20 to the tailgate 22.

As shown in FIG. 1, an accessory rail system 30 comprises a first rail 32 that is extendable along the first side wall 14 that defines the cargo area 12 and a second rail 34 that is extendable along the second side wall 16. In implementations, the first rail 32 and the second rail 34 each include at least one mount interface 36 to attach to a respective one of the first side wall 14 and the second side wall 16. In implementations, the first rail 32 extends substantially along an entirety of the first side wall 14, and the second rail 34 extends substantially along an entirety of the second side wall 16, from the front bed wall 20 until just short of the tailgate 22.

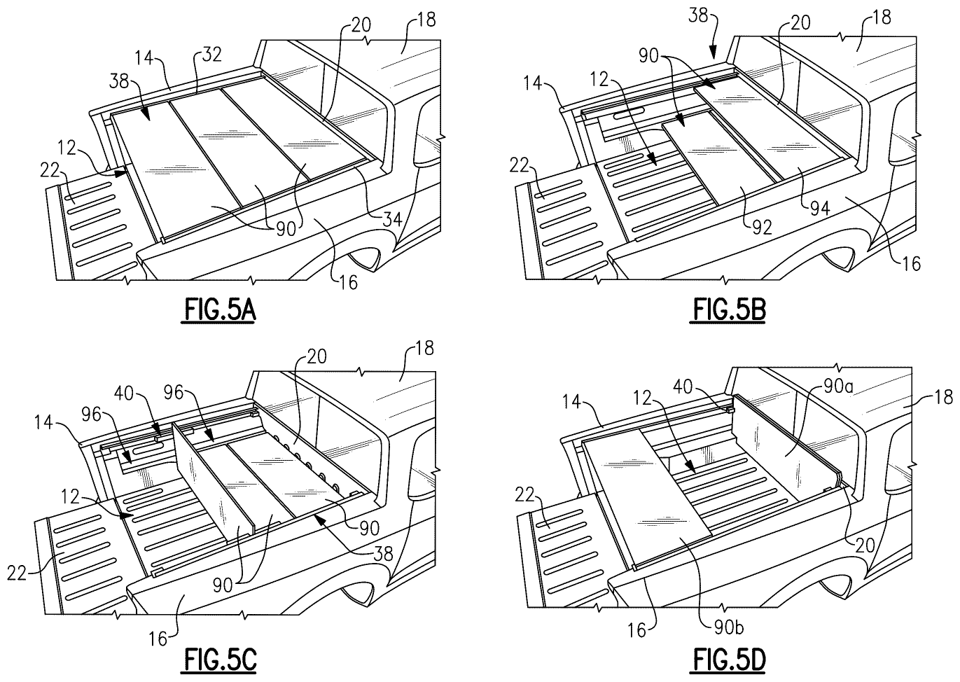

One or more accessories 38 (see FIGS. 3 and 5A-5D) are selectively mountable to at least one of the first rail 32 and the second rail 32.

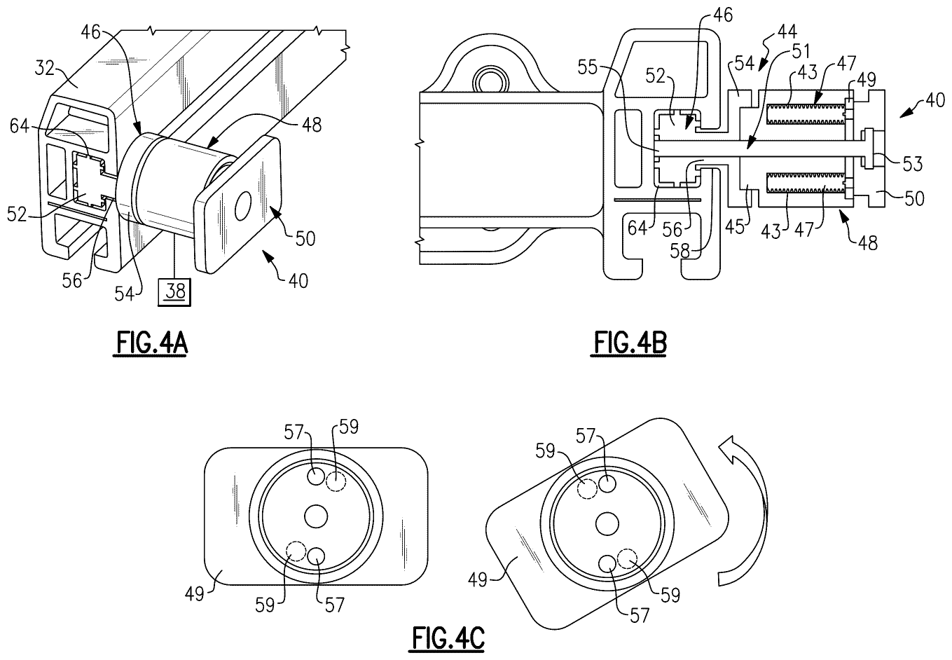

In implementations, one or more accessory attachment sliders 40 (FIGS. 4A-4C) can be installed in the first rail 32 and the second rail 34. Each accessory attachment slider 40 is selectively moveable or actuatable between a locked position to hold an associated accessory 38 in a fixed position and an unlocked position to allow the accessory 38 to be slid to a desired position.

In implementations, at least one connector 42 is associated with each mount interface 36. The connectors 42 fix a respective one of the first rail 32 and the second rail 34 to and associated one of the first side wall 14 and the second side wall 16. In one example, the connectors 42 comprise fastening elements such as screws, bolts, etc.; however, other types of connectors could also be used.

In implementations, at least one protector 60 is associated with the first rail 32 and the second rail 34 and is selectively moveable between an accessible position and a non-accessible position.

In one example, when the protector 60 is in the accessible position, each mount interface 36 is accessible to remove or attach the first rail 32 and the second rail 34 from an associated side wall 14 or 16, or each of the first rail 32 and second rail 34 are accessible to remove or attach the one or more accessories 38.

In one example, when the protector 60 is in the non-accessible position each mount interface 36 is inaccessible to remove or attach the first rail 32 and the second rail 34, or each of the first rail 32 and second rail 34 are inaccessible to remove or attach the one or more accessories 38.

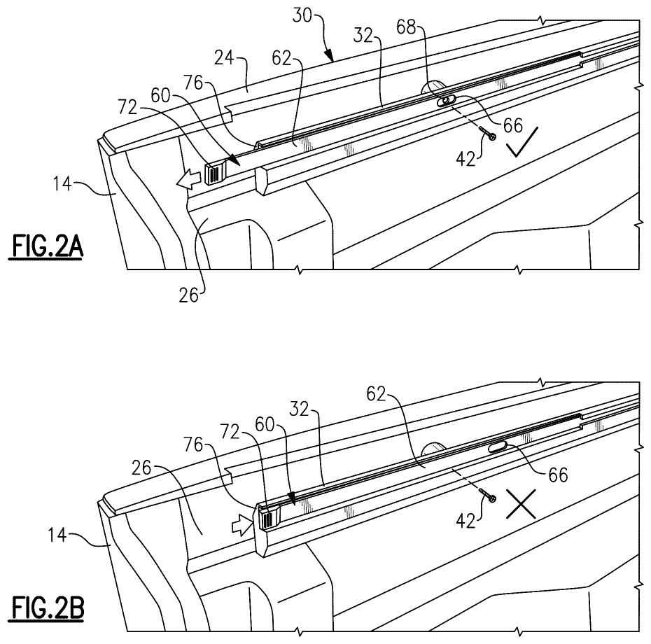

One example of a protector 60 is shown in FIGS. 2A-2B. In this example, the protector 60 comprises a bar 62 that is slidably received within a track 64 formed in each of the first rail 32 and the second rail 34. FIGS. 2A-2B only show the first rail 32 on the first side wall 14, it should be understood that the second rail 34 on the second side wall 16 would be similarly configured.

In implementations, each bar 62 includes at least one window or opening 66 such that when the bar 62 is in the accessible position the opening 66 is aligned with the mount interface 36 (FIG. 2A), and when the bar 62 is in the non-accessible position the opening 66 is not aligned with the mount interface 36 (FIG. 2B).

In one example, each mount interface 36 includes a first mounting opening 68 formed in an associated one of the first rail 32 and the second rail 34, and a second mounting opening 70 (schematically shown in FIG. 1) formed in an associated one of the first side wall 14 and the second side wall 16. The connector 42 is insertable through the first mounting opening 68 and the second mounting opening 70 to fix a respective one of the first rail 32 and the second rail 34 to an associated one of the first side wall 14 and the second side wall 16.

As shown in FIG. 2A, when the bar 62 is in the accessible position, the opening 66 is aligned with the first mounting opening 68 and the second mounting opening 70. As shown in FIG. 2B, when the bar 62 is in the non-accessible position the opening 66 is not aligned with the first mounting opening 68 and the second mounting opening 70.

In one example, the bar 62 comprises a flat elongated body that has handle 72 at a distal end 74. In implementations, when installed in the track 64, the flat elongated body has a length extending in the longitudinal direction, a width extending in the vertical direction, and a thickness extending in the lateral direction. In one example, the length is significantly longer than the width, and the thickness is significantly less than the width.

In implementations, each of the first rail 32 and the second rail 34 extend to a distal end 76 that faces the tailgate 22 that is moveable between an open position and a closed position. When the tailgate 22 is in the closed position (FIG. 3), the bar 62 is prevented from moving to the accessible position. When the tailgate 22 is in the open position, the bar 62 is moveable in a longitudinal direction toward the distal end 76 of the rails 32, 34 to achieve the accessible position. In one example, the handle 72 is grasped by a user to pull the bar 62 back and forth between the closed and open positions.

In one example shown in FIG. 1, each mount interface 36 comprises the mounting opening 70 in the first side wall 14 or second side wall 16 and the mounting opening 68 in an associated one of the first rail 32 and the second rail 34 that are aligned with each other to allow the first rail 32 and the second rail 34 to be flush mounted to a respective one of the first side wall 14 and the second side wall 16.

In one example shown in FIG. 3, each mount interface 36 comprises a post 78 that offsets the first rail 32 and the second rail 34 from the inner wall surface 26 of a respective one of the first side wall 14 and the second side wall 16. In this example, accessories 38 such as bands, cables, or ropes for example, can be routed around the post 78 and/or the rails 32, 34.

Another type of protector 60′ is associated with securing the accessories 38 and/or sliders 40 within the cargo area 12. In implementations, the protector 60′ comprises the tailgate 22 that is moveable between an open position (FIG. 1) and a closed position (FIG. 3). When the tailgate 22 is in the closed position and locked, slidable accessories 40 (FIG. 4A) are not removable from the first rail 32 and the second rail 34 as shown in FIG. 3, and when the tailgate 22 is in the open position, the slidable accessories 40 are removable from the first rail and the second rail.

In one example, each of the first rail 32 and the second rail 34 have a track 64 that extends to the distal end 76 of the rails 32, 34, wherein the track 64 has an open end face. The accessories 38 are selectively detachable and attachable to the first rail 32 and the second rail 34 by accessing the track 64 via the open end face. When the tailgate 22 is in the closed position, the open end face is closed off and the accessories 38 cannot be removed. When the tailgate 22 is in the open position, the open end face is open and accessories 38 can be removed from the rails 32, 34 by sliding out of the track 64.

In implementations, one or more accessory attachment sliders 40 are received in the first rail 32 and the second rail 34. In on example, the accessories 38 are supported by the accessory attachment sliders 40. In one example, the accessories 38 such as cables, ropes, bands, etc. can be routed around the sliders 40 (see FIG. 3), or the accessories 38 may be fixed to the sliders 40 with fasteners or other types of attachment interfaces. For example, accessories 38 such as cameras, boxes, panels, tools, racks, shelves, etc., may be mounted to the sliders 40.

Once installed in one of the first rail 32 and the second rail 34, the accessory attachment slider 40 is actuatable between an unlocked position where the accessory attachment slider 40 is freely slidable along the first rail 32 and the second rail 34, and a locked position where the accessory attachment slider 40 is held in a fixed location in the at least one of the first rail 32 and the second rail 34.

In implementations, the accessory attachment slider 40 includes a lock mechanism 44 (FIG. 4B) that is selectively actuated to lock and unlock the slider 40 to the respective rail 32, 34. In one example shown in FIG. 4A, the accessory attachment slider 40 includes a first body portion 46, a second body portion 48, and a knob 50. In one example, the first body portion 46 includes including a slide block 52 and a receiver portion 54 that interfaces with the second body portion 48. The slide block 52 is received for sliding movement within the track 64. A narrowing neck portion 56 extends through a slot 58 of the track 64 that faces the cargo area 12 and connects the slide block 52 to the receiver portion 54. In one example, the second body portion 48 comprises a cylindrical body having one or more internal cavities 43, and having a reduced section end face 45 received within the receiver portion 54. In one example, the internal cavities 43 house resilient members 47, e.g., springs, that are have one end at a closed end face of the cavity 43 and react against an end plate 49 that is associated with the knob 50. A shaft 51 has a head portion 53 received within an open-faced cavity of the knob 50, and extends to a distal end 55 that reacts against a surface of the track 64 that is opposite from the slot 58.

To move to the locked position, a user rotates the knob 50 which causes the knob 50, the shaft 51, and the second body portion 48 with the resilient members 47, to rotate together. This compresses the end 55 of the shaft 51 against the rail 32, 34 in one direction to prevent sliding movement of the slider 40. The slide block 52 is fixed in rotation, due to a threaded attachment between the shaft 51 and the block 52, which causes the block 52 to compress into the rail 32, 34 in an opposite direction. The end face of the plate 49 includes ball detents 57 (FIG. 4C) that face the internal cavity 43. After a rated compressive force is reached, a specified torsional load is generated within the shaft 51. The ball detents 57 are rated with a compressive force corresponding to the torsional load. The ball detents 57 require that a user twisting the knob 50 needs to apply enough torque to overcome the compressive force in the ball detents 57.

As shown in FIG. 4C, when the ball detents 57 are depressed, the knob 50 twists separately from the second body portion 48 and shaft 51, and sits the detents 57 into a new cavity 59. This gives the user tactile feedback that the accessory slider 40 has reached the rated compressive force and is locked against the rail 32, 34, e.g., the accessory slider 40 cannot move along the rail 32, 34. To unlock the accessory slider 40, the above described steps are reversed.

In implementations shown in FIGS. 5A-5D, the accessories 38 comprise one or more panels 90 that are supported by the first rail 32 and the second rail 34 in one of a plurality of different configuration. In one example, accessory sliders 40 may be used to facilitate attachment of the panels to the rails 32, 34.

FIG. 5A shows one example comprising a security cover configuration. In this example, there are a plurality of panels 90 that extend from the front bed wall 20 to the tailgate 22 to provide a protective cover over the cargo area 12. When the tailgate 22 is closed and locked, the panels 90 prevent outsiders from accessing the cargo area contents.

FIG. 5B shows one example comprising a tiered cargo configuration. In this example, there are a plurality of panels 90 that are offset from each other to provide one or more support shelves 92, as well as a cover 94, for example.

FIG. 5C shows one example comprising a cargo divider configuration. In this example, at least one panel 90 is placed in an upright orientation to divide the cargo area 12 into multiple separate compartments 96.

FIG. 5D shows one example comprising an aero cover configuration. In this example, a forward panel 90a is positioned upright near the front bed wall 20 and a rearward panel 90b is laid in flat position along the rails 32, 34 near the tailgate 22 to provide a desired aerodynamic effect. The panels could also be placed in different arrangements to provide any desired aerodynamic effect.

In implementations, there may be a first protector 60 that is moveable between an accessible position and a non-accessible position relative to the mount interface 36, and a second protector 60′ that is moveable between an accessible position to attach or remove the accessories 38 or sliders 40 and a non-accessible position where the accessories 38 and sliders 40 cannot be removed or attached.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A system, comprising:
a first rail extendable along a first side wall defining a cargo area;
a second rail extendable along a second side wall defining a cargo area, and wherein the first rail and the second rail each include at least one mount interface to attach to a respective one of the first side wall and the second side wall;
one or more accessories that are selectively mountable to at least one of the first rail and the second rail; and
at least one protector associated with the first rail and the second rail, wherein the at least one protector is moveable between an accessible position and a non-accessible position, and wherein
in the accessible position each mount interface is accessible to remove or attach the first rail and the second rail, or each of the first rail and second rail are accessible to remove or attach the one or more accessories, and
in the non-accessible position each mount interface is inaccessible to remove or attach the first rail and the second rail, or each of the first rail and second rail are inaccessible to remove or attach the one or more accessories.

2. The system of claim 1, including at least one connector associated with each mount interface, wherein the at least one connector fixes a respective one of the first rail and the second rail to and associated one of the first side wall and the second side wall.

3. The system of claim 2, wherein the at least one protector comprises a bar that is slidably received within a track formed in each of the first rail and the second rail, and wherein each bar includes at least one opening such that when the bar is in the accessible position the at least one opening is aligned with the at least one mount interface, and when the bar is in the non-accessible position the at least one opening is not aligned with the at least one mount interface.

4. The system of claim 3, wherein each mount interface includes a first mounting opening formed in an associated one of the first rail and the second rail, and a second mounting opening formed in an associated one of the first side wall and the second side wall, and wherein the at least one connector is insertable through the first mounting opening and the second mounting opening to fix a respective one of the first rail and the second rail to an associated one of the first side wall and the second side wall.

5. The system of claim 4, wherein, when the bar is in the accessible position, the at least one opening is aligned with the first mounting opening and the second mounting opening, and when the bar is in the non-accessible position the at least one opening is not aligned with the first mounting opening and the second mounting opening.

6. The system of claim 5, wherein each of the first rail and the second rail extend to a distal end that faces a tailgate that is moveable between an open position and a closed position, and wherein when the tailgate is in the closed position, the bar is prevented from moving to the accessible position, and when the tailgate is in the open position, the bar is moveable toward the distal end to achieve the accessible position.

7. The system of claim 1, wherein each mount interface comprises a post that offsets the first rail and the second rail from a respective one of the first side wall and the second side wall.

8. The system of claim 1, wherein each mount interface comprises a first mounting opening in the first side wall or second side wall and a second mounting opening in an associated one of the first rail and the second rail that are aligned with each other to allow the first rail and the second rail to be flush mounted to a respective one of the first side wall and the second side wall.

9. The system of claim 1, wherein the at least one protector comprises a tailgate that is moveable between an open position and a closed position, and wherein, when the tailgate is in the closed position, accessories are not removable from the first rail and the second rail, and when in the open position, accessories are removable from the first rail and the second rail.

10. The system of claim 9, wherein each of the first rail and the second rail have a track that extends to a distal end with an open end face, and wherein the one or more accessories are selectively detachable and attachable to the first rail and the second rail by accessing the track via the open end face, and wherein when the tailgate is in the closed position, the open end face is closed off, and when the tailgate is in the open position, the open end face is open.

11. The system of claim 1, wherein the one or more accessories comprise one or more panels that are supported by the first rail and the second rail in one of a plurality of different configurations, and wherein the plurality of different configurations include at least a cargo divider configuration, an aero cover configuration, a security cover configuration, or a tiered cargo configuration.

12. The system of claim 1, wherein the first rail extends substantially along an entirety of the first side wall and wherein the second rail extends substantially along an entirety of the second side wall.

13. The system of claim 1, wherein the at least one protector comprises at least a first protector that is moveable between an accessible position and a non-accessible position relative to the at least one mount interface, and at least a second protector that is moveable between an accessible position to attach or remove the one or more accessories and a non-accessible position where the one or more accessories cannot be removed or attached.

14. The system of claim 1, including at least one accessory attachment slider that is received in at least one of the first rail and the second rail, wherein the one or more accessories are supported by the at least one accessory attachment slider, and wherein, once installed in the at least one of the first rail and the second rail, the at least one accessory attachment slider is actuatable between an unlocked position where the at least one accessory attachment slider is freely slidable along the first rail and the second rail and a locked position where the at least one accessory attachment slider is held fixed in the at least one of the first rail and the second rail.

15. A method comprising:
mounting a first rail along a first side wall defining a cargo area via at least a first mount interface;
mounting a second rail along a second side wall defining the cargo area via at least a second mount interface;
selectively mounting one or more accessories to at least one of the first rail and the second rail; and
associating at least one protector with the first rail and the second rail, wherein the at least one protector is moveable between an accessible position and a non-accessible position, and wherein
in the accessible position each mount interface is accessible to remove or attach the first rail and the second rail, or each of the first rail and second rail are accessible to remove or attach the one or more accessories, and
in the non-accessible position each mount interface inaccessible to remove or attach the first rail and the second rail, or each of the first rail and second rail are inaccessible to remove or attach the one or more accessories.

16. The method of claim 15, including installing at least one connector the first mount interface to fix the first rail to the first side wall and installing at least one connector the second mount interface to fix the second rail to the second side wall.

17. The method of claim 16, wherein the at least one protector comprises a bar, and including sliding the bar within a track formed in each of the first rail and the second rail, and providing at least one opening in each bar such that when the bar is in the accessible position the at least one opening is aligned a respective one of the first mount interface and the second mount interface, and when the bar is in the non-accessible position the at least one opening is not aligned with the respective one of the first mount interface and the second mount interface.

18. The method of claim 17, wherein each of the first mount interface and the second mount interface includes a first mounting opening formed in an associated one of the first rail and the second rail, and a second mounting opening formed in an associated one of the first side wall and the second side wall, and including inserting the at least one connector through the first mounting opening and the second mounting opening to fix a respective one of the first rail and the second rail to an associated one of the first side wall and the second side wall.

19. The method of claim 18, wherein, when the bar is in the accessible position, the at least one opening is aligned with the first mounting opening and the second mounting opening, and when the bar is in the non-accessible position the at least one opening is not aligned with the first mounting opening and the second mounting opening, and wherein each of the first rail and the second rail extend to a distal end that faces a tailgate that is moveable between an open position and a closed position, and including preventing the bar from moving to the accessible position by moving the tailgate to the closed position, and allowing the bar to move to the accessible position by moving the tailgate to the open position.

20. The method of claim 15, wherein the at least one protector comprises a tailgate that is moveable between an open position and a closed position, and including removing accessories from the first rail and the second rail by moving the tailgate to the open position, and preventing accessories from being removed from the first rail and the second rail by moving the tailgate to the closed position, and optionally:
including sliding at least one accessory attachment slider in at least one of the first rail and the second rail, supporting the one or more accessories with the at least one accessory attachment slider, and wherein, once installed in the at least one of the first rail and the second rail, the at least one accessory attachment slider is actuatable between an unlocked position where the at least one accessory attachment slider is freely slidable along the first rail and the second rail and a locked position where the at least one accessory attachment slider is held fixed in the at least one of the first rail and the second rail.
